(19) United States
(12) Patent Application Publication
(10) Pub. No.: US 2006/0141869 A1
(43) Pub. Date: Jun. 29, 2006

(54) Tube for transporting fluid

(76) Inventors: Atsuo Miyajima, Inuyama-shi (JP); Koji Shimizu, Nagoya-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/316,513

(22) Filed: Dec. 22, 2005

(30) Foreign Application Priority Data
Dec. 24, 2004 (JP) 2004-374801
Dec. 16, 2005 (JP) 2005-364135

(51) Int. Cl. H01R 24/00

(52) U.S. Cl. 439/676

(57) ABSTRACT

A tube for transporting a fluid is provided integrally with a quick connector on a tube end portion. The quick connector has a tubular connector housing defined by the tube end portion in a form of diametrically enlarged shape, an O-ring contacting with an outer peripheral surface of a mating pipe to provide a seal, and a retainer portion. The retainer portion has a retainer tubular portion defined by a leading end portion of the connector housing and an engaging recessed portion. The engaging recessed portion allows an engaging projection of the mating pipe to fit in the engaging recessed portion resiliently or under a resilient force from an inner side toward a radially outward direction in a mutually engaging relation.

### BACKGROUND OF THE INVENTION

1. Field of the Invention

The present invention relates to a tube for transporting a fluid, specifically, the one provided with a means for connecting the tube for transporting a fluid with a mating pipe.

2. Description of the Related Art

Previously, a hard resin tube has been widely used for transporting various fluids. For connecting the resin tube with a mating pipe, used is a quick connector that is constructed separately therefrom.

Such type of a quick connector is disclosed, for example, in Patent Document 1 below.

FIGS. 9 and 10 show a concrete example of construction of this quick connector.

In FIGS. 9 and 10, reference numeral 200 indicates a tube, and reference numeral 202 is a mating pipe to which the tube 200 is to be connected.

The mating pipe 202 is formed with an annular bulge portion (engaging projecting portion) 204 bulging radially outward on an outer peripheral surface thereof.

Reference numeral 206 indicates a quick connector. The quick connector 206 is entirely made of resin except for an O-ring 214 that will be, described later. The quick connector 206 may be made of material other than the resin.

The quick connector 206 comprises a tubular connector housing 208 for covering a connecting portion of the mating pipe 202 from outside, and a nipple portion 210 having a diameter smaller than the connector housing 208 and projecting therefrom rightward in the figure.

The nipple portion 210 serves as a press-fit portion in the tube 200. The nipple portion 210 is formed with annular ribs 212 at a plurality of axially spaced or different positions on an outer peripheral surface thereof. The annular rib 212 has a saw-edged cross-section and is provided with an acute angled peak.

The quick connector 206 is securely fixed in the tube 200 by press-fitting the nipple portion 210 in the tube 200.

At that time, the annular ribs 212 formed on the outer peripheral surface of the nipple portion 210 serve as stoppers relative to the tube 200 by biting in an inner surface of the tube 200 that is deformed radially outward by press-fitting.

Meanwhile, an annular groove is formed in the outer peripheral surface of the nipple portion 210, an O-ring 214 made of rubber as an elastic seal ring is held in the annular groove, and a seal is provided by the O-ring 214 between the nipple portion 210 and the tube 200.

In an inner peripheral surface of the connector housing 208, a ring-shaped resin collar 216 and a bush 218 for axially aligning the mating pipe 202 with the connector housing 208, and the O-ring 214 as a seal ring that contacts with the mating pipe 202 and provides a seal are incorporated and held. A leading end portion of the connector housing 208 defines a tubular retainer holding portion 220.

The retainer holding portion 220 is a portion to hold a retainer 226 that will be described later. The retainer holding portion 220 is formed with a mounting window 222 radially through a wall of the retainer holding portion 220, and the retainer 226 is incorporated in the retainer holding portion 220 by use of the mounting window 222.

A portion of a leading end of the retainer holding portion 220 beyond the mounting window 222 is defined as a latching or stop portion 224.

The retainer 226 is a resin member in a form of generally annular shape as a whole, and is resiliently deformable in a radial direction.

The retainer 226 is provided with a window opening or opening window 228 formed through a wall of the retainer 226 and a latching recess 230. The window opening 228 serves as an engaging recess in which the bulge portion 204 as an engaging projection of the mating pipe 202 is fitted from an inner side toward radially outside. The bulge portion 204 is fitted in the window opening 228 in engaging relation. The latching recess 230 is also latched to the above latching or stop portion 224 on a side of the retainer holding portion 220 from radially inside.

The retainer 226 is held in the retainer holding portion 220 in fixed relation in an axial direction in such manner that the latching recess 230 is latched to the latching portion 224 of the retainer holding portion 220

The retainer 226 is further includes an inner peripheral surface thereof that defines a tapered inner peripheral cam surface 232, and an outer peripheral surface that defines a tapered outer peripheral cam surface or a tapered outer cam surface 234.

When the mating pipe 202 is inserted inside the retainer 226 in an axial direction, the inner peripheral cam surface 232 abuts the bulge portion 204 and guides the bulge portion 204 for further axial movement. Then the inner peripheral cam surface 232 resiliently diametrically expands the retainer 226 as a whole, for example, by the cam action as the bulge portion 204 moves and thereby allows passage of the bulge portion 204 to a position of the window opening 228.

Then, as soon as the bulge portion 204 reaches a position of the window opening 228, the retainer 226 as a whole returns to its original shape, the bulge portion 204 simultaneously is fitted or slipped in the window opening 228, and the mating pipe 202 is securely fixed in stopped relation relative to the retainer 226 in an axial direction.

On the other hand, when the retainer 226 is inserted in the connector housing 208, specifically in the retainer holding portion 220 in the axial direction, the outer peripheral cam surface 234 abuts the latching portion 224, thereby resiliently diametrically contracts the retainer 226 as a whole, and latches the latching recess 230 onto the latching portion 224 with diametrically contracting action of the retainer 226.

In the quick connector 206, the nipple portion 210 of the quick connector 206 is first press-fitted and securely fixed in the tube 200 as shown in FIG. 10. Then, in this state, the mating pipe 202 is inserted in the quick connector 206. Thereby the mating pipe 202 may be connected to the tube 200 quickly and easily with simple operation.

As shown in FIG. 9(A), two O-rings 214 are used in the quick connector 206. However, as shown in FIG. 9(B), as the case may be, single O-ring 214 may be used in the quick connector 206 for compact sizing of the quick connector 206.

However, in case of conventional connecting structure using this quick connector 206, as the quick connector 206 is provided separately for connecting the mating pipe 202 with the tube 200, number of required parts is increased, and this inevitably leads to increase of required cost. And, this entails a problem that a number of man-hour is required for assembling work relative to the tube 200 including press-fitting work of the quick connector 206 in the tube 200, specifically press-fitting work of the nipple portion 210 in the tube 200, connecting procedure of the tube 200 becomes bothersome, and cost for connecting the tube 200 to the mating pipe 202 is increased.

Meanwhile the above explanation is given about a resin tube as a representative of a tube for transporting a fluid, the same problem may be caused when a joint such as the above quick connector 206 is used for connecting other hard tube for transporting a fluid such as a metal tube with the mating pipe 202.

For the purpose of solving the above stated problem that number of required parts is increased due to use of the quick connector 206, Patent Document 2 below discloses a technique that a tube for transporting a fluid is formed integrally with a housing for housing a sealing member inside.

However, in case of this tube for transporting a fluid, an elastic member of specific shape that is incorporated inside the tube serves both as a seal and as a stopper relative to a mating pipe. In this construction, there is not only a problem that the elastic member of shape intended for a seal and a stopper is required, but also a problem that it is difficult to secure a high bonding force between the tube and the mating pipe in an axial direction.

[Patent Document 1] JP-A, 11-201355

[Patent Document 2] JP-A, 2001-200963

Under the circumstances described above, it is an object of the present invention to provide a tube for transporting a fluid, that may be easily connected to a mating pipe with small number of man-hour and small number of parts, and thereby may reduce cost for required parts and working cost for connecting the tube with the mating pipe.

### SUMMARY OF THE INVENTION

According to the present invention, there is provided a novel tube for transporting a fluid, that is provided with a quick connector on a tube end portion or an end portion of the tube, for example, integrally or in unitary relation. The quick connector comprises a tubular connector housing defined by the tube end portion in a form of diametrically enlarged shape, a seal ring incorporated and held in the connector housing, and a retainer portion. The seal ring contacts with an outer peripheral surface of a mating pipe to provide a seal between the mating pipe and the quick connector or the connector housing. The retainer portion has a retainer tubular portion defined by a leading end portion of the connector housing and an engaging recessed portion formed in the retainer tubular portion. The engaging recessed portion allows an engaging projection of the mating pipe that is inserted in the connector housing to fit in the engaging recessed portion resiliently or under a resilient force (for example, under a resilient force of the retainer portion) from an inner side toward radially outward direction in a mutually engaging relation. This engaging relation of the engaging projection with the engaging recessed portion securely fixes the mating pipe in a stopped relation relative to the retainer tubular portion or the connector housing in an axial direction.

The engaging recessed portion may be defined by a window opening or opening window in a form of slit formed radially through a wall of the retainer tubular portion.

The retainer tubular portion may be resilient, and may have an oblong sectional shape. For example, the retainer portion allows the engaging projection of the mating pipe to pass and move to a position of the engaging recessed portion when diametrical or opposite portions of the retainer tubular portion along a long diameter, a long axis or a major axis thereof (herein after referred to as long diametrical portions or first diametrical portions) are resiliently deformed in a diametrically contracting direction (along with a resilient deformation of the long diametrical portions of the retainer tubular portion in a diametrically contracting direction), and the retainer portion allows the engaging projection of the mating pipe to fit in the engaging recessed portion when the retainer tubular portion returns to an original oblong shape is thereof. Here, the retainer portion may be configured such that the long diametrical portions of the retainer tubular portion are resiliently deformed in a diametrically contracting direction, and diametrical or opposite portions of the retainer tubular portion along a short diameter, a short axis or a minor axis thereof (herein after referred to as short diametrical portions or second diametrical portions) are resiliently deformed in a diametrically enlarging direction when a force is exerted to the long diametrical portions from a radially outer side in a radially inward direction. Or, the retainer portion may be configured such that the engaging projection of the mating pipe abuts the short diameter portions of the retainer tubular portion, and then, the engaging projection advances while resiliently deforming the short diameter portions in the diametrically enlarging direction with accompanying resilient deformation of the long diametrical portions of the retainer tubular portions.

A flexural modulus of the connector housing or the retainer portion (retainer tubular portion) may be in a range of 300 to 2500 MPa according to ASTM D790.

As stated above, according to the present invention, the tube for transporting a fluid is provided with a quick connector on a tube end portion, for example, integrally or in unitary relation. The quick connector comprises the tubular connector housing, for example, in a form of the tube end portion of diametrically enlarged shape, the seal ring incorporated in the connector housing, and the retainer portion having the retainer tubular portion, for example, in a form of the leading end portion of the connector housing and the engaging recessed portion formed in the retainer tubular portion. According to the present invention, number of parts required for connecting the tube for transporting a fluid with the mating pipe may be decreased, and procedure or labor for attaching the separate quick connector to the tube may be omitted, and thereby a man-hour required for connecting the tube to the mating pipe may be decreased. So, totally, required cost may be largely reduced.

The tube for transporting a fluid of the present invention provides, for example, a strong connection with the mating pipe.

Here, the engaging recessed portion of the above retainer portion may be in a form of a slit-shaped window opening formed through a wall of a leading end portion of the connector housing, namely the retainer tubular portion in a radial direction.

In this manner, the engaging recessed portion in which the engaging projection of the mating pipe is fitted in engaging relation may be fabricated in a very simple structure.

The retainer tubular portion may be constructed to be resilient and have an oblong sectional shape. Here, the retainer tubular portion allows the engaging projection of the mating pipe to pass and move to a position of the engaging recessed portion, when the long diametrical portions of the retainer tubular portion is resiliently deformed in a diametrically contracting direction (along with resilient deformation of the long diametrical portions of the retainer tubular portion in the diametrically contracting direction). When the thus deformed retainer tubular portion returns to an its original oblong shape, for example, resiliently or under a resilient force of the retainer tubular portion, the engaging projection is allowed to fit in the engaging recessed portion in engaging relation. In this manner, the retainer portion may be fabricated in a very simple structure. The retainer tubular portion (at least a portion of the retainer tubular portion extending from the engaging recessed portion toward a leading end or outer end thereof) is formed to have a section of an oblong shape (an oblong shape may be a shape like a circle flattened in a radial direction, a shape like a circle or annular shape where a long diameter and a short diameter are at right angle each other, an ellipse or oval shape, or generally ellipse or generally oval shape). The retainer tubular portion is configured, for example, such that a distance between the long diametrical portions (a pair of the long diametrical portions) is greater than an outer diameter of the engaging projection of the mating pipe, and a distance between the short diametrical portions (a pair of the short diametrical portions) is smaller than the outer diameter of the engaging projection of the mating pipe (the distance between the short diametrical portions is, for example, greater than an outer diameter of a portion of the mating pipe other than the engaging projection). Here, the distance between the short diametrical portions may be designed equal to or slightly larger than the outer diameter of the engaging projection of the mating pipe on leading end portions or outer end portions of the short diametrical portions. And, the retainer portion is configured so as to allow the engaging projection of the mating pipe to advance to the engaging recessed portion when narrowing the distance between the long diametrical portions and widening the distance between the short diametrical portions. For example, the retainer tubular portion is configured so that the distance between the long diametrical portions is narrowed and the distance between the short diametrical portions is widened by exerting a compressing force from a radially outer side in a radially inward direction to the long diametrical portions. Or, for example, the retainer tubular portion may be configured so that the engaging projection of the mating pipe abuts the short diametrical portions and relatively advances while widening the distance between the short diametrical portions. As the engaging projection advances, the distance between the long diametrical portions is narrowed. In order to facilitate the engaging projection to widen the distance between the short diametrical portions, the short diametrical portions may be formed with a guide on an inner surface side or the engaging projection may be formed with a tapered surface. The retainer tubular portion is allowed to resiliently return to its original shape or the retainer tubular portion resiliently returns to its original shape, and thereby the engaging projection engages with or in the engaging recessed portion, when the engaging projection of the mating pipe relatively reach a position of the engaging recessed portion.

When a flexural modulus of the retainer tubular portion is less than 300 MPa, the retainer tubular portion lacks sufficient hardness, it is feared that the mating pipe connected to the retainer tubular portion is easily disengaged. Also, when the flexural modulus of the retainer tubular portion exceeds 2500 MPa, the retainer tubular portion has a too high hardness resulting that the mating pipe is hard to be connected to the retainer tubular portion. Therefore, the flexural modulus of the connector housing, the retainer portion, or the retainer tubular portion is preferably in a range of 300 MPa to 2500 MPa according to ASTM D790.

Now, the preferred embodiments will be described in detail with reference to the drawings.

### BRIEF DESCRIPTION OF THE DRAWINGS

FIG. 1 is a perspective view of a tube for transporting a fluid according to the present invention, showing a state that the tube is connected to a mating pipe.

FIG. 2(A) is a sectional view of the tube of FIG. 1, taken along A-A line of FIG. 3.

FIG. 2(B) is a sectional view of the tube of FIG. 1, taken along B-B line of FIG. 3.

FIG. 3 is a front view (partly showing in section) of the tube of FIG. 1.

FIG. 4(A) is a front view of the tube of FIG. 1, showing a state that the tube is not connected with the mating pipe.

FIG. 4(B) is a perspective view of the tube of FIG. 1, showing a state that the tube is not connected with the mating pipe.

FIG. 4(C) is a partly broken away side view of the tube of FIG. 1, showing a state that the tube is not connected with the mating pipe.

FIG. 5(A) is a half-sectional view for explaining an action of a preferred embodiment, showing a state that insertion of the mating pipe in a quick connector is just started.

FIG. 5(B) is another half-sectional view for explaining the action of the preferred embodiment, showing the state that insertion of the mating pipe in the quick connector is just started.

FIG. 5(C) is a front view for explaining the action of the preferred embodiment, showing the state that insertion of the mating pipe in the quick connector is just started.

FIG. 6(A) is a half-sectional view for explaining the action of the preferred embodiment, showing a step following a step of insertion of the mating pipe in the quick connector in FIG. 5.

FIG. 6(B) is another half-sectional view for explaining the action of the preferred embodiment, showing the step following the step of insertion of the mating pipe in the quick connector in FIG. 5.

FIG. 6(C) is a front view for explaining the action of the preferred embodiment, showing the step following the step of insertion of the mating pipe in the quick connector in FIG. 5.

FIG. 7(A) is a front view of a tube for transporting a fluid according to another preferred embodiment of the present invention.

FIG. 7(B) is a sectional view of the tube of the another preferred embodiment, taken along C-C line of FIG. 7(A).

FIG. 8 is a view showing a mating pipe that has a difference shape from that of the mating pipe of FIG. 1.

FIG. 9(A) is a view showing a conventional example for connecting a resin tube with a pipe by a connector.

FIG. 9(B) is a view showing the connector of FIG. 9(A), where an exactly one seal ring is used.

FIG. 10(A) is a view of a relevant part of the connector of FIG. 9 along with the resin tube, showing a state before the connector is press-fitted in the resin tube.

FIG. 10(B) is a view of the relevant part of the connector of FIG. 9, showing a state that the connector is press-fitted in the tube.

### DETAILED DESCRIPTION OF THE PREFERRED EMBODIMENTS

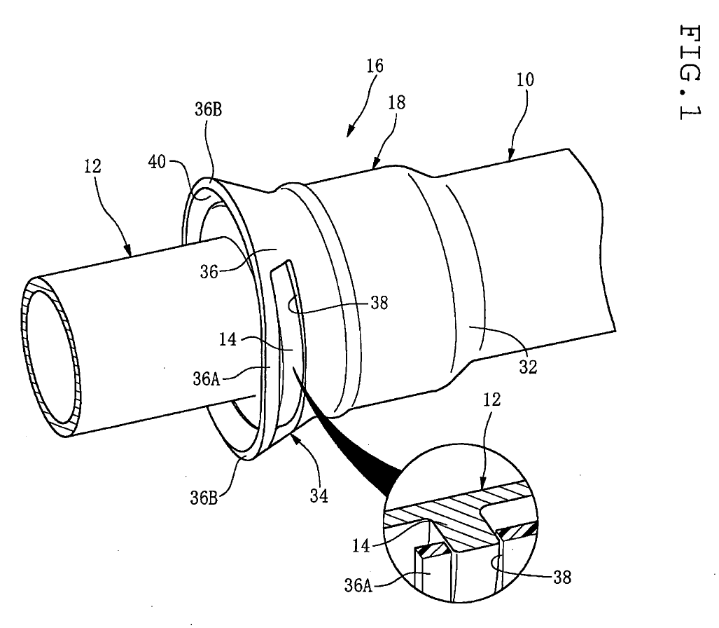

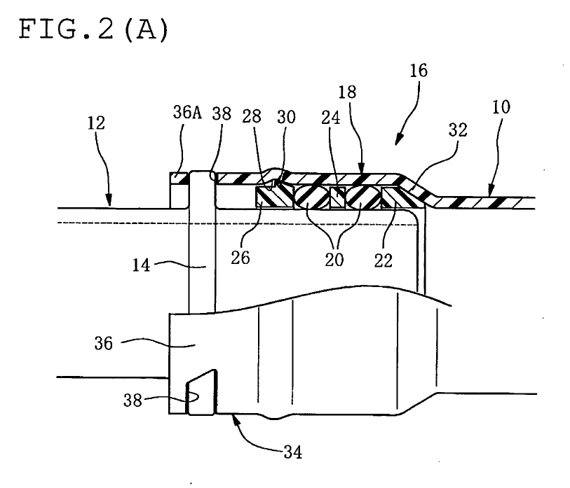

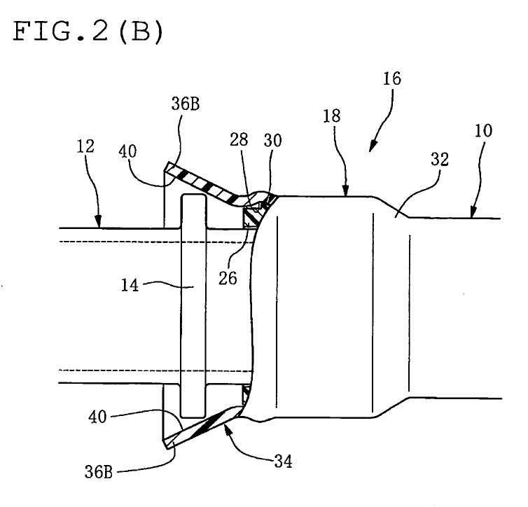

In FIGS. 1 and 2, reference numeral 10 indicates a hard tube (here, made of resin) for transporting a fluid, and reference numeral 12 indicates a hard mating pipe with which the tube 10 is connected.

The mating pipe 12 is formed integrally with an engaging projection 14 that projects annularly from an outer peripheral surface of the mating pipe 12.

In this preferred embodiment, the tube 10 is provided integrally with a quick connector 16 on an end portion thereof.

Meanwhile, the tube 10 is configured to have a flexural modulus in a range of 300 MPa to 2500 MPa on an end portion thereof. And, the tube 10 may have a multilayered construction as follows. For example, the layers are is bonded each other by means of an adhesive agent (adhesive layer).

1) An inner layer made of ethylene-tetrafluoroethylene copolymer (ETFE) and an outer layer made of nylon 12 (PA12).

2) An electrically conductive inner layer made of ETFE, a middle layer made of ETFE, and an outer layer made of PA12.

3) An inner layer made of polyphenylene sulfide (PPS), an adhesive layer and an outer layer made of PA12.

4) An inner layer made of ETFE, an adhesive layer, a middle layer made of PPS, an adhesive layer, and an outer layer made of PA12.

5) An electrically conductive inner layer made of ETFE, an adhesive layer, a middle layer made of PPS, an adhesive layer and an outer layer made of PA12.

6) An inner layer made of modified polybutylene terephthalate (modified PBT), an inner middle layer made of polybutylene napthalate (PBN), an outer middle layer made of modified PBT, and an outer layer made of an elastomer of polybutylene terephthalate type (PBT type).

7) An inner layer made of modified PBT, an inner middle layer made of polybutylene terephthalate (PBT), an outer middle layer made of an elastomer of PBT type and an outer layer made of an elastomer of PBT type.

This quick connector 16 has a tubular connector housing 18 that is defined by a tube end portion of the tube 10 in a form of a diametrically enlarged shape. In the connector housing 18, elastic O-rings 20 made of rubber as seal rings, ring-shaped collars 22, 24 made of resin and a bush 26 made of resin for axially aligning the mating pipe 12 with the connector housing 18 (for aligning the mating pipe 12 with the connector housing 18 relative to an axis) are incorporated and held in an inner peripheral surface thereof.

Here, the bush 26 is formed with an annular protrusion 30 protruding radially outward.

On the other hand, the connector housing 18 is formed with an annular depressed portion 28 that is depressed radially outward from a radially inner side. The annular protrusion 30 is fitted in the annular depressed portion 28, and thereby the bush 26, O-rings 20, and collars 24, 22 that are located behind the bush 26 are incorporated in the connector housing 18 while positioned in an axial direction. Here, the depressed portion 28 may be formed by press-fitting the bush 26 in the connector housing 18.

Meanwhile, a base region of the connector housing 18 defines a tapered stepped portion 32, against which the collar 22 abuts in the axial direction.

A portion on a leading end of the connector housing 18 defines a retainer portion 34. The retainer portion 34 has a retainer tubular portion 36 that is defined by a leading end portion of the connector housing 18, and a pair of window openings or opening windows 38 radially through a wall of the retainer tubular portion 36 as engaging recessed portions.

The retainer portion 34 is a portion that serves to securely fix the mating pipe 12 in stopped relation relative to the connector housing 18 in the axial direction by fitting the engaging projection 14 of the mating pipe 12 in the window openings 38 radially outward from an inner side in engaging relation.

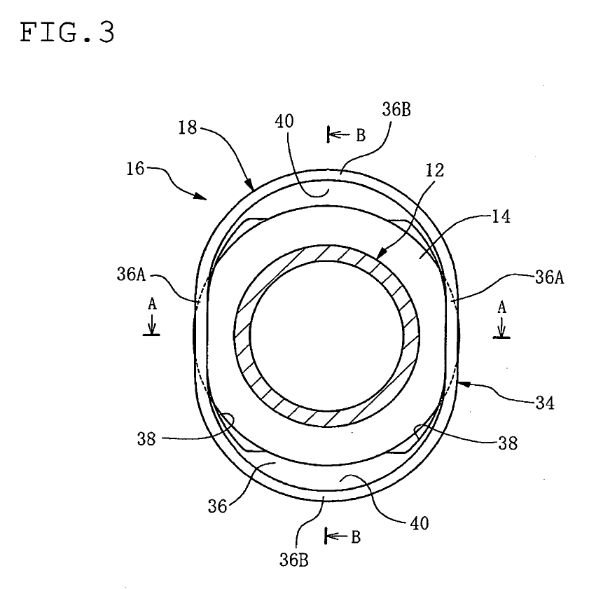

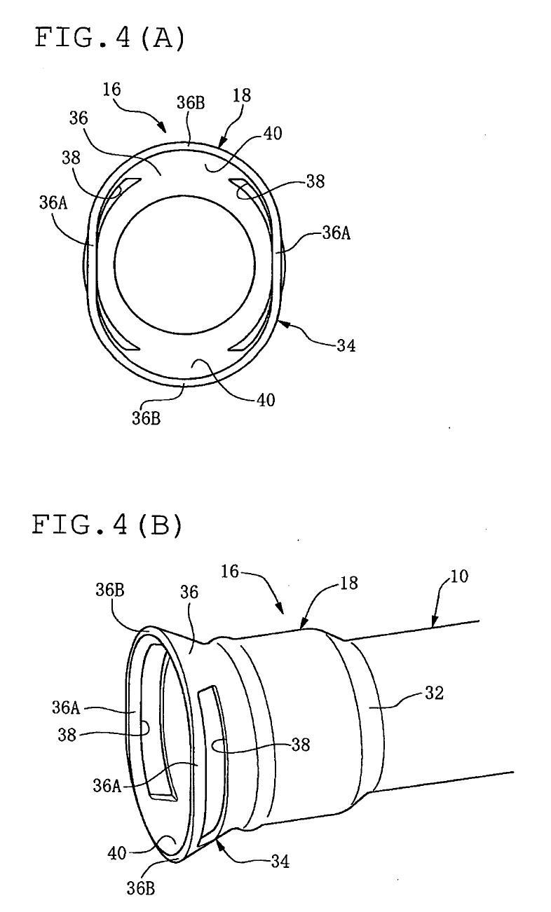

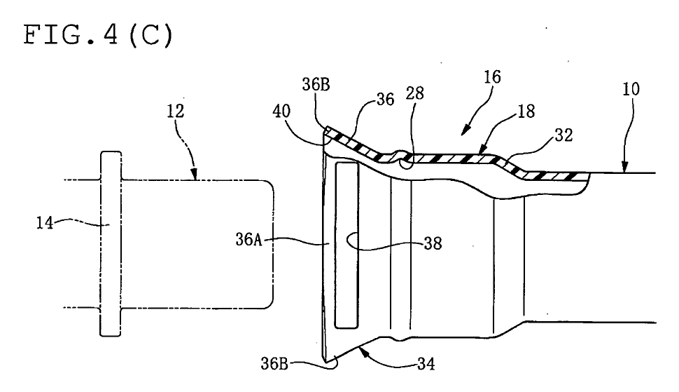

The above retainer tubular portion 36 has an oblong section as shown in FIGS. 3 and 4, and is formed with a pair of above opening windows 38, 38 in short diametrical portions 36A of the retainer tubular portion 36 (portions of right and left sides of the retainer tubular portion 36 in the FIGS. 3 and 4(A)).

Here, a distance between the short diametrical portions 36A or inner surfaces of the short diametrical portions 36A is smaller than an outer diameter of the engaging projection 14 of the mating pipe 12 in its original shape. On the other hand, a distance between long diametrical portions 36B of the retainer tubular portion 36 or inner surfaces of the long diametrical portions 36B is larger than the outer diameter of the engaging projection 14. A long diameter and a short diameter are at right angle each other.

Each of the long diametrical portions 36B has a shape diametrically enlarging gradually from a base toward a leading end of the retainer tubular portion 36, and inner surfaces thereof define slant surfaces 40.

Meanwhile, the retainer tubular portion 36 is resiliently deformable entirely in a radial direction.

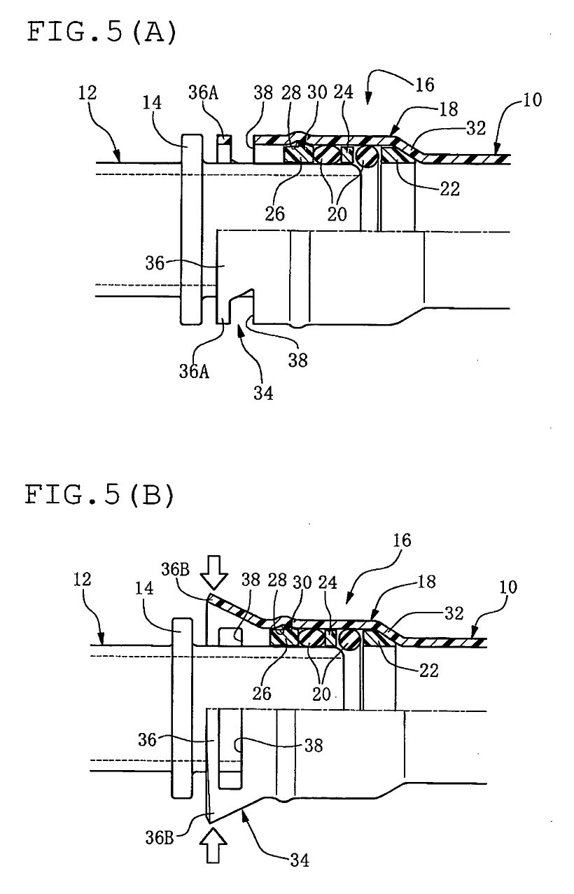

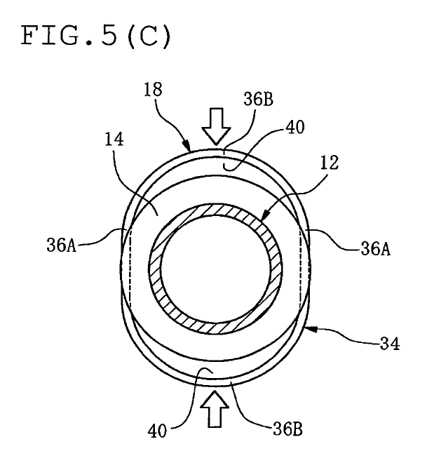

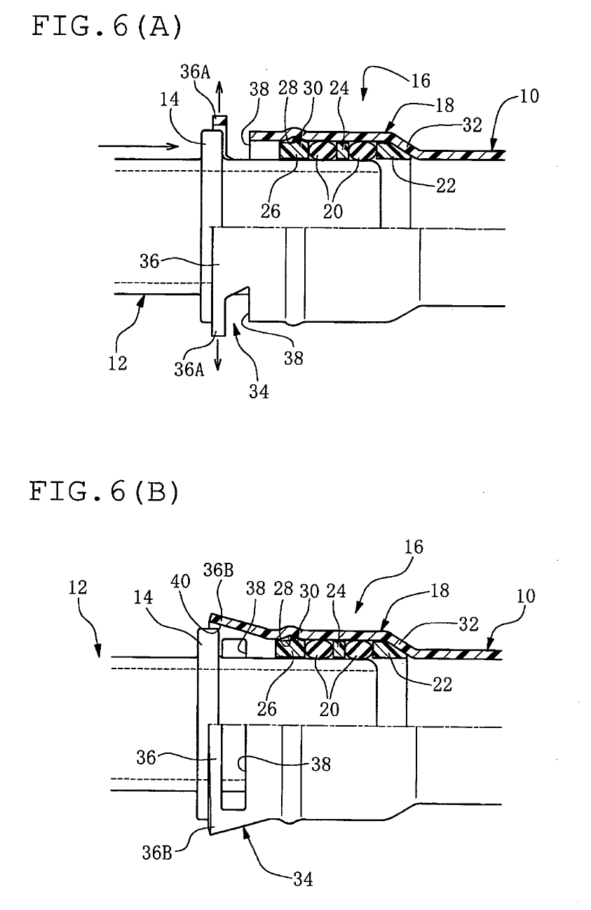

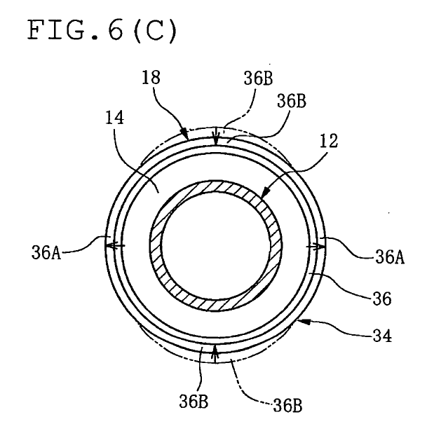

As shown in FIGS. 5 and 6, in order to connect the mating pipe 12 with the tube 10 according to this preferred embodiment, first, a leading end portion of the mating pipe 12 (a portion on a leading end of the mating pipe 12) is inserted inside the quick connector 16 as shown in FIGS. 5(A) and 5(B), and the retainer tubular portion 36 is resiliently deformed by exerting a force to the long diametrical portions 36B in a diametrically contracting direction as shown in FIG. 5(C) (refer to also FIG. 6(C)).

In this manner, the short diametrical portions 36A are widen radially outward, and the engaging projection 14 of the mating pipe 12 is thereby allowed to be inserted inside the retainer tubular portion 36.

And, when the engaging projection 14 reaches a position of the opening windows 38 of the retainer portion 34, and, a force exerted in a direction indicated by an arrow in FIG. 5(C) is cancelled, the retainer tubular portion 36 returns to its original shape thanks to its own resiliency, and simultaneously, the engaging projection 14 is fitted in the pair of the opening windows 38 of the retainer portion 34 in engaging relation. Then, the mating pipe 12 is securely fixed in the quick connector 16, namely relative to the tube 10 in stopped relation in the axial direction.

On the other hand, the O-rings 20 incorporated in the inner peripheral surface of the connector housing 18 closely contact with the leading end portion of the mating pipe 12 (the portion of the leading end of the mating pipe 12), specifically an outer peripheral surface of a portion on a leading end of the mating pipe 12 relative to the engaging projection 14 at this time, and provide a seal between the mating pipe 12 and the connector housing 18, is namely between the mating pipe 12 and the tube 10.

When the mating pipe 12 connected with the tube 10 needs to be pulled out the tube 10, engagement between the engaging projection 14 and the opening windows 38 is cancelled by exerting a force in the direction indicated by the arrow in FIG. 5(C) to resiliently deform the retainer tubular portion 36, and the mating pipe 12 is pulled out of the tube 10, namely out of the quick connector 16.

According to the preferred embodiment as above, number of parts required for connecting the tube 10 for transporting a fluid with the mating pipe 12 may be decreased, procedure for attaching the quick connector 16 to the tube 10 may be omitted, and thereby number of man-hour required for connecting the tube 10 with the mating pipe 12 may be decreased. So, it becomes possible to largely reduce total required cost.

The engaging recessed portions of the retainer portion 34 are configured by the window openings 38 in a form of slit formed radially through the wall of the retainer tubular portion 36. So, the engaging recessed portion in which the engaging projection 14 of the mating pipe 12 is fitted in engaging relation may be configured with a very simple structure.

And, according to the preferred embodiment, the retainer tubular portion 36 is resilient and has an oblong section. And, thanks to its resilient deformation, the retainer tubular portion 36 allows the engaging projection 14 of the mating pipe 12 to engage and disengage with the window openings 38 of the retainer portion 34. So, the retainer portion 34 may be configured with a very simple structure.

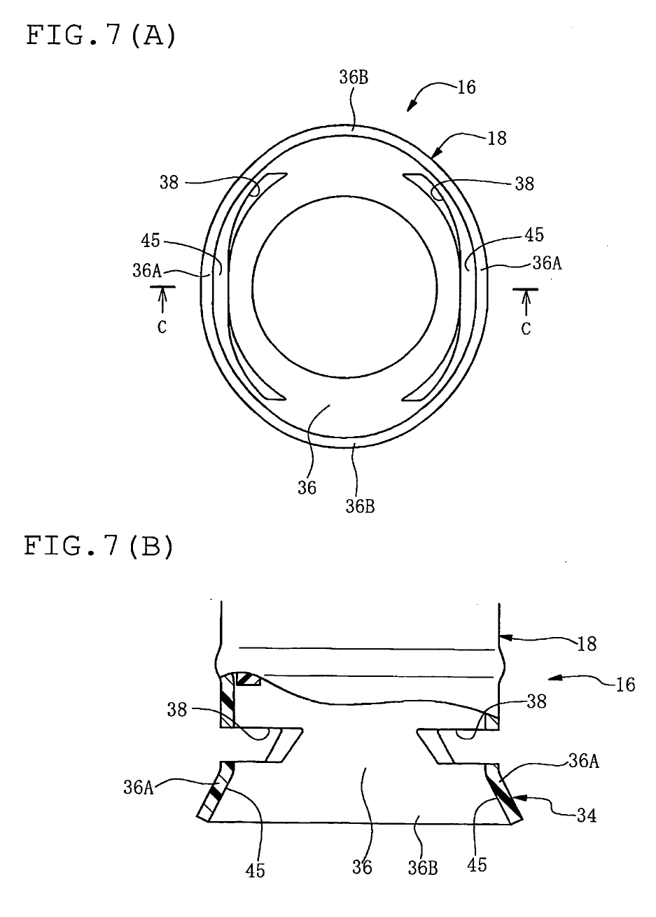

As shown in FIG. 7, guide surfaces 45 may be also defined by inner surfaces of the short diametrical portions 36A of the retainer tubular portion 36. The guide surfaces 45 abut the engaging projection 14 and guide the engaging projection 14 for movement in an inserting direction when the pipe 12 is relatively inserted. In this manner, insertion of the mating pipe 12 within the connector housing 18 may be smoothly conducted. For example, when the mating pipe 12 is inserted in the connector housing 18, the engaging projection 14 abuts the guide surfaces 45 of the short diametrical portions 36A and advances while pushing the guide surfaces 45 in a diametrically enlarging direction, thereby the short diametrical portions 36A are deformed in the diametrically enlarging direction, and the long diametrical portions 36B are deformed in a diametrically contracting direction.

Further, along with insertion of the mating pipe 12, the long diametrical portions 36B of the retainer tubular portion 36 of oblong section may be automatically deformed in a diametrically contracting direction, and the short diametrical portions 36A may be automatically deformed in the diametrically enlarging direction. It is convenient as it becomes possible that the engaging projection 14 is fitted in the window openings 38 of the retainer portion 34 in engaged and stopped relation due to deformation thereof simply by inserting the mating pipe 12.

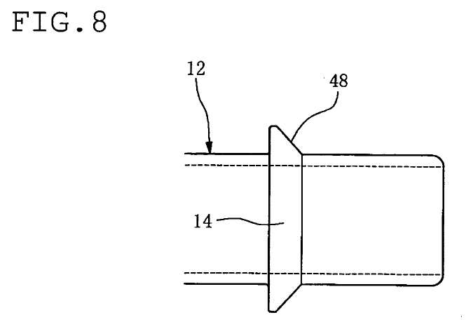

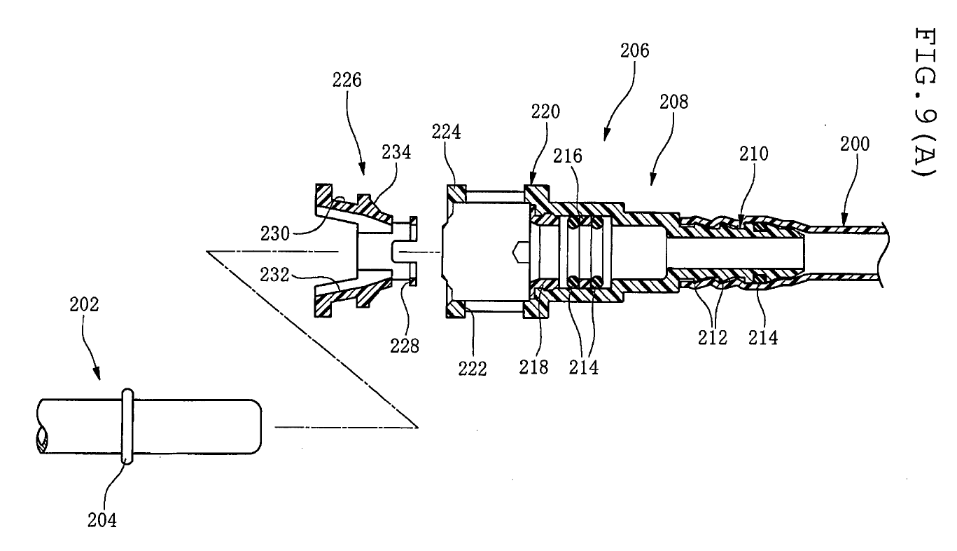

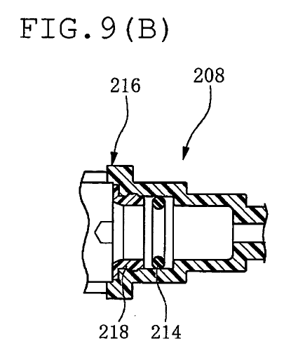

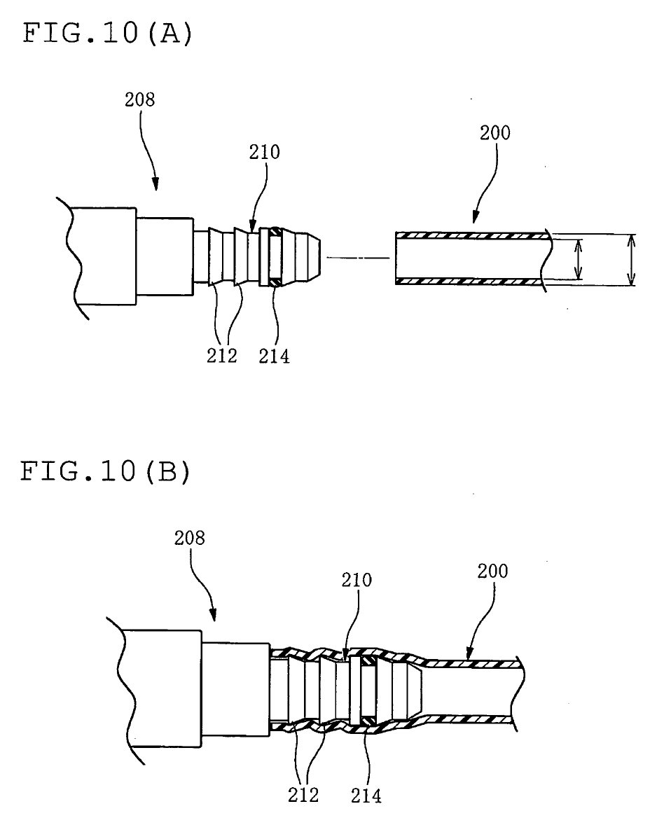

Meanwhile, instead of defining the above guide surface 45 by the inner surface of the retainer tubular portion 36, or simultaneously with defining the guide surface 45 thereby, as shown in FIG. 8, the engaging projection 14 of the mating pipe 12 may be formed with a guide surface 48 such as a tapered guide surface for guiding the mating pipe 12 when the mating pipe 12 is inserted. For example, when the mating pipe 12 is inserted in the connector housing 18, the guide surface 48 of the engaging projection 14 abuts the short diametrical portions 36A or the guide surfaces 45 of the short diametrical portions 36A and advances while pushing the short diametrical portions 36A or the guide surfaces 45 of the short diametrical portions 36A in the diametrically enlarging direction, thereby the short diametrical portions 36A are deformed in the diametrically enlarging direction, and the long diametrical portions 36B are deformed in the diametrically contracting direction.

Although the preferred embodiments have been described above, these are only some of preferred embodiments of the present invention.

For example, in the above preferred embodiments, the retainer tubular portion 36 is formed with the opening window 38 radially through the wall thereof as the engaging recessed portion. However, the engaging recessed portion may be formed not through the wall of the retainer tubular portion 36 or may be formed in various other configurations.

And, although the tube 10 that is explained in the above preferred embodiments is made of resin, the tube 10 may have a multilayered construction by laminating a resin material and a metal material. Or the tube 10 may be made only of the metal material.

The present invention may be constructed and embodied in various configurations and modes within the scope of the present invention.

What is claimed is:

1. A tube for transporting a fluid, provided with a quick connector on a tube end portion, the quick connector, comprising:
a tubular connector housing defined by the tube end portion in a form of diametrically enlarged shape,
a seal ring incorporated and held in the connector housing, the seal ring contacting with an outer peripheral surface of a mating pipe to provide a seal,
a retainer portion having a retainer tubular portion defined by a leading end portion of the connector housing and an engaging recessed portion formed in the retainer tubular portion, and
wherein the engaging recessed portion allows an engaging projection of the mating pipe that is inserted in the connector housing to fit in the engaging recessed portion resiliently or under a resilient force from an inner side toward radially outward direction in a mutually engaging relation, the engaging relation of the engaging projection with the engaging recessed portion securely fixes the mating pipe in a stopped relation in an axial direction.

2. The tube for transporting a fluid as set forth in claim 1, wherein the engaging recessed portion is defined by a window opening in a form of slit formed through a wall of the retainer tubular portion in a radial direction.

3. The tube for transporting a fluid as set forth in claim 1, wherein the retainer tubular portion is resilient, and has an oblong sectional shape, the retainer portion allows the engaging projection of the mating pipe to pass and move to a position of the engaging recessed portion when diametrical portions of the retainer tubular portion along a long diameter thereof are resiliently deformed in a diametrically contracting direction, and the retainer portion allows the engaging projection of the mating pipe to fit in the engaging recessed portion in engaging relation when the retainer tubular portion returns to an original oblong shape thereof.

4. The tube for transporting a fluid as set forth in claim 3, wherein the retainer portion is configured such that the diametrical portions of the retainer tubular portion along the long diameter thereof are resiliently deformed in a diametrically contracting direction, and diametrical portions of the retainer tubular portion along a short diameter thereof is resiliently deformed in the diametrically enlarging direction when a force is exerted to the diametrical portions along the long diameter from radially outside in a radially inward direction.

5. The tube for transporting a fluid as set forth in claim 3, wherein the retainer portion is configured such that the engaging projection of the mating pipe abuts diametrical portions of the retainer tubular portion along a short diameter thereof, and then, the engaging projection advances while resiliently deforming the diametrical portions along the short diameter in a diametrically enlarging direction with accompanying resilient deformation of the diametrical portions of the retainer tubular portion along the long diameter thereof in the diametrically contracting direction.

6. The tube for transporting a fluid as set forth in claim 1, wherein a flexural modulus of the connector housing or the retainer portion is in a range of 300 to 2500 MPa according to ASTM D790.
